(19) United States
(12) Patent Application Publication
(10) Pub. No.: US 2026/0254088 A1
(43) Pub. Date: Aug. 27, 2026

(54) WAVEGUIDE ARRAY WITH ROUNDED CROSS-SECTION

(71) Applicant: SWISSto12 SA, Renens (CH)

(72) Inventors: Mathieu Billod, Présilly (FR); Alban Mourier, Lausanne (CH); Esteban Menargues Gomez, Préverenges (CH)

(21) Appl. No.: 19/162,814

(22) PCT Filed: Mar. 11, 2024
(86) PCT No.: PCT/IB2024/052334

§ 371 Date: Sep. 5, 2025

(30) Foreign Application Priority Data
Mar. 13, 2023 (CH) CH000284/2023

(51) Int. Cl. H01P 3/123; H01P 11/00; H01Q 21/06; H01Q 21/24

(52) U.S. Cl. CPC H01P 3/123; H01Q 21/064; H01Q 21/24; H01P 11/002

(57) ABSTRACT

A waveguide array (1) obtained by additive manufacturing comprising an even number of waveguides arranged in pairs so as to form at least one waveguide pair, each waveguide pair comprising:
a first waveguide channel (10), and
a second waveguide channel (11);
the first and second channels comprising a non-circular oval cross-section with an axis of symmetry (x) and at least one non-straight portion,
the first waveguide and the second waveguide having a common wall portion (100).

### TECHNICAL FIELD

The present invention relates to a waveguide array and an antenna array comprising such a waveguide array.

### BACKGROUND ART

Radiofrequency waveguide arrays are widely used in many areas of telecommunications, particularly in satellite telecommunications.

Satellite payload constraints limit the space and weight available for all onboard components, particularly antenna components and other passive radio frequency devices.

Additive manufacturing of such devices offers the advantage of complex geometries that optimize the space occupied by the devices and a manufacturing method that requires very few assembly steps, thereby reducing manufacturing time and cost. However, additive manufacturing also has certain constraints, particularly in terms of device geometry, in order to be feasible.

There is therefore a need for passive radio frequency devices that are optimized for compactness, minimized in weight, and have a geometry suitable for additive manufacturing.

There is also a need for alternative waveguide array geometries to offer designers greater design freedom.

Waveguide networks often comprise matrix arrangements of rectangular cross-section waveguides, or honeycomb arrangements of hexagonal cross-section waveguides. In these arrangements, each waveguide except those at the edge of the array shares all its walls with adjacent waveguides. This sharing of walls reduces the weight and footprint of the array.

Contrary to what one might intuitively imagine, these arrangements in which all walls are shared do not always allow for an optimal ratio between the surface area of the channels and the surface area of the walls. This is because the walls of the waveguides must be thick enough to ensure the rigidity of the network and heat dissipation. This significant thickness of all the walls tends to make the network heavier and bulkier.

Furthermore, additive manufacturing of waveguide networks with rectangular or hexagonal cross-sections is difficult due to the number of cantilevered walls during printing.

Networks formed by circular cross-section waveguides arranged in a matrix have also been devised. In this arrangement, each waveguide shares only a very limited length of its contour with its neighbors, for example four points. The ratio between the surface area of the channels and the surface area of the walls is therefore unfavorable.

### BRIEF SUMMARY OF THE INVENTION

One aim of the present invention is to provide a waveguide network free from the limitations present in the prior art.

Another aim of the invention is to provide a waveguide network that facilitates additive manufacturing.

Another purpose of the invention is to provide a waveguide array that limits the number of assembly steps during manufacture.

Another purpose of the invention is to provide a waveguide array with optimized compactness.

Another purpose of the invention is to provide a waveguide network that is lighter than waveguide networks in the prior art.

According to the invention, these objectives are achieved in particular by means of a network of waveguides obtained by additive manufacturing comprising waveguides arranged in pairs so as to form at least one pair of waveguides, each pair of waveguides comprising:
a first waveguide channel, and
a second waveguide channel;
the first and second channels comprise a non-circular oval cross-section with an axis of symmetry and at least one non-straight portion,
and in that the first waveguide and the second waveguide have a common wall portion.

An oval section is a section formed by a closed differentiable curve, which has at least one axis of symmetry and which resembles more or less an ellipse. Elliptical, egg-shaped, stadium-shaped and peanut-shaped forms are, for example, considered in the present application to be ovals.

Compared to networks formed by waveguides with circular cross-sections, the oval shape increases the portion of common walls shared between neighboring waveguides, thereby improving the ratio between the wall surface area and the channel surface area.

The oval shape also offers the advantage of generally being easier to produce by additive manufacturing than other shapes that have more cantilevered portions.

Oval shapes cannot be juxtaposed perfectly on a plane without leaving gaps between them. These gaps, which are usually considered undesirable, are exploited in the invention by filling them, at least partially, to create locally thicker walls that reinforce the rigidity of the device and improve heat dissipation. As a result, the other portions of the walls shared between these reinforcement areas can be printed with a thinner thickness. Thus, contrary to what one might think at first glance, the imperfect juxtaposition of waveguide channels with the claimed shape makes it possible to create reinforcement zones which ultimately reduce the thickness of the other walls, and therefore reduce the weight and bulk of the network compared to networks formed of waveguides with a rectangular or hexagonal cross-section in which all the walls are shared.

In a variant, these reinforcement zones can be pierced with openings to dissipate heat and further reduce the weight of the network.

In a first embodiment, the first and second channels comprise a non-circular oval section with two axes of symmetry.

The waveguide channels alternately comprise, along their longest dimension, a first convex end, a concave connecting portion, and a second convex end.

The connecting portion may comprise two concave walls facing each other.

The dimension of the channel in a direction perpendicular to said longest dimension is greater at said ends than in the connecting portion.

In this embodiment, the channel section is thus substantially peanut-shaped.

The contour of the ends forms, for example, a circular arc of at least 190°, preferably at least 210°. The connecting portion may connect to these ends in a direction tangential to these circular arcs.

A concave wall of the concave connecting portion may have a ridge.

Two inner walls of the first waveguide and two inner walls of the second waveguide may each comprise a ridge.

The network may comprise a first line (or slice) of waveguides juxtaposed in the direction of their greatest elongation, and a second line (or slice) of waveguides juxtaposed in the direction of their greatest elongation, the second line being offset by half a waveguide length relative to the first line. Thus, a convex portion of each waveguide rests against the convex connecting portion of a waveguide on an adjacent line.

In another embodiment, the waveguide channels alternately have, along their longest dimension, a first convex end and a second end formed by two non-parallel walls.

The waveguide channels then have a substantially waterdrop shape.

The non-parallel walls meet to form the second end of the channel.

The contour of the first convex end may form a circular arc of at least 180°.

Non-parallel walls can extend the first convex end along two tangents.

Each channel may have one or more ridges.

The network according to this second embodiment may comprise a first line of waveguides juxtaposed in a direction perpendicular to their greatest elongation, and a second line of waveguides juxtaposed in the direction of their greatest elongation, the two lines being head-to-tail, the second line being offset by half a waveguide width relative to the first line.

The network may comprise a third line of waveguides juxtaposed in a direction perpendicular to their greatest elongation, and a fourth line of waveguides juxtaposed in the direction of their greatest elongation, the third line being juxtaposed with the second line.

The waveguide network may further comprise Y-junctions to function as a combiner network.

A dual-polarization antenna array obtained by additive manufacturing may comprise a waveguide network as above, and a plurality of radiating elements, each radiating element being coupled to the end of exactly one pair of waveguides of the network.

A section matching portion may be provided between each waveguide and each radiating element.

A septum may be provided between each radiating element and a pair of waveguides.

Such an antenna array may comprise at least eight waveguides, with the pairs of waveguides being arranged contiguously in a first direction and in a second direction, such that two successive pairs in the first direction have at least one waveguide wall in common and such that two successive pairs in the second direction have at least one waveguide wall in common.

The invention may also relate to a waveguide network for transmitting a single polarization, comprising several waveguide lines (or slices), each line comprising power combiners, bent waveguides and straight sections, in which the straight waveguides of each line have sections as described in the first or second embodiment.

The invention may also relate to a waveguide network for transmitting two polarizations, comprising at least one waveguide line (or slice) for transmitting a first polarization signal and at least one second waveguide line (or slice) for transmitting a second polarization signal, each line comprising power combiners, bent waveguides and straight sections, wherein the straight waveguides of each line have sections as described in the first or second embodiment.

### BRIEF DESCRIPTION OF THE FIGURES

Examples of embodiments of the invention are shown in the description illustrated by the accompanying figures, in which:

FIG. 1 schematically illustrates a cross-sectional view of a waveguide according to a first embodiment.

FIG. 2 schematically illustrates a cross-sectional view of a waveguide according to a first embodiment, here provided with a single ridge.

FIG. 3 schematically illustrates a cross-sectional view of a waveguide network according to the first embodiment.

FIG. 3 schematically illustrates a cross-sectional view of a waveguide network according to a second embodiment.

### EXAMPLE(S) OF EMBODIMENTS OF THE INVENTION

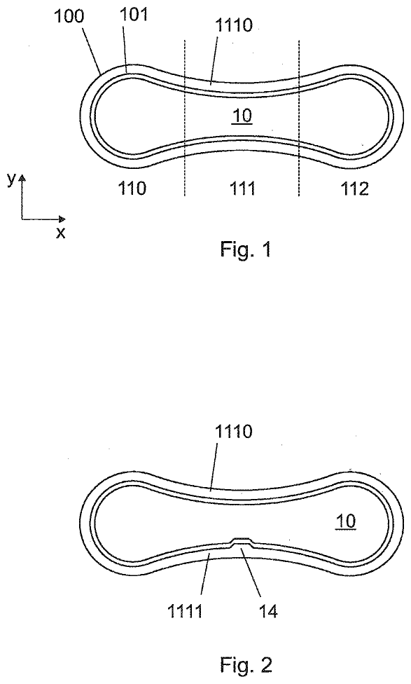

FIG. 1 shows the cross-section of a waveguide according to a first embodiment, which is substantially peanut-shaped. The waveguide comprises a core 100 produced by additive manufacturing, for example a metal core, and a conductive coating 101 on an inner wall of this core.

The cross-section of the waveguide channel 10 is oval, non-circular, and has a first axis of symmetry in the direction of greatest elongation x, as well as a second axis of symmetry in a direction y perpendicular to this direction of greatest elongation.

In the direction of the greatest elongation x, the channel 10 alternately has a first convex end 110, a concave connecting portion 111, and a second convex end 112. The dimension of the channel in the y direction perpendicular to said greatest elongation x is greater at said ends than in the connecting portion.

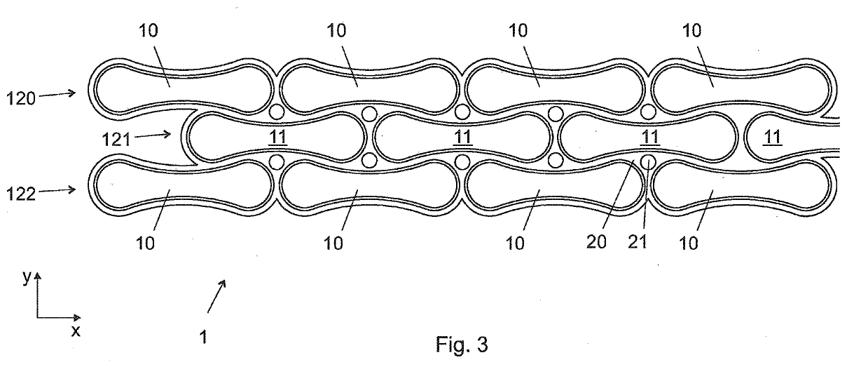

The connecting portion 11 has two concave portions 1110, 1111 facing each other. These concave portions form two ridges facing each other, allowing certain transmission modes to be filtered. An additional ridge 14 may be provided on one of the concave sections to reinforce this filtering, as illustrated in FIG. 2. It is also possible to provide more than one ridge of this type in the channel.

The walls of the ridges 14 can be adapted to facilitate their additive manufacturing. For example, the angles between the walls of the ridges and the printing direction can be adapted to limit the cantilevered portions. Alternatively or in addition, the ridges may include rounded portions to facilitate additive printing.

The contour of the ends 110, 112 may form an arc of at least 190°, preferably at least 210°. It is also possible to provide ends of different shapes.

The sections of the connecting portions 1110 extend the end sections to which they are connected along tangents, so as to form a continuous and differentiable curve.

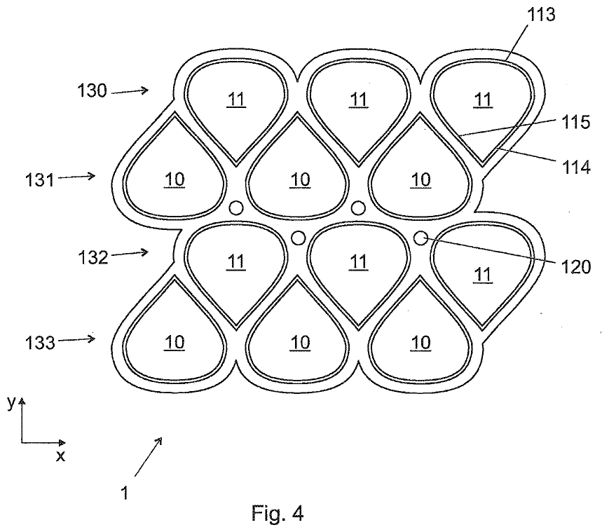

The wall of the waveguide shown in FIG. 1 is substantially constant. A network is formed by juxtaposing several waveguides of this shape, as shown in FIG. 3. Portions of the walls of adjacent waveguides are then shared.

The juxtaposition of waveguides according to FIGS. 1 and 2 leaves areas unoccupied by the elementary patterns of FIG. 1. These areas can be filled with metal during additive manufacturing, thus forming areas of mechanical reinforcement and for heat dissipation. As the mechanical rigidity and heat dissipation are enhanced by these areas, it is possible to reduce the thickness of the waveguide walls in other areas, thereby reducing the weight and size of the network.

Optional longitudinal openings 21 can be provided in these reinforcement zones 20 to cool the network and make it even lighter.

The waveguide network advantageously comprises an even number of waveguides. The waveguides of the network are arranged in pairs so as to form waveguide pairs. Each pair of waveguides comprises a first waveguide 10 for propagating an electromagnetic wave having a first polarization P1 and a second waveguide 11 for propagating an electromagnetic wave having a second polarization P2. Thus, each pair of waveguides can support two polarizations. These pairs are characterized in that the waveguides forming them share a portion of wall.

It is also possible to provide a network of one of the types described in this description, but in which each waveguide transmits the same polarization.

The waveguide network is formed by creating waveguide lines. A first line 120 is formed by juxtaposing waveguides in an x direction perpendicular to their greatest elongation. A second line 121 is formed by juxtaposing other waveguides in the direction of their greatest elongation. The two lines are assembled by shifting the second line 121 by half a waveguide width relative to the first line 120.

FIG. 4 illustrates a waveguide network produced by additive manufacturing, according to a second embodiment. Each waveguide 10, 11 has a cross-section that is substantially waterdrop-shaped.

The waveguide comprises a core 100 produced by additive manufacturing, for example a metal core, and a conductive coating 101 on an inner wall of this core.

The cross-section of the waveguide channel 10 is oval, non-circular, and has a single axis of symmetry in the direction of the greatest elongation x.

In the direction of the greatest elongation x, the channel 10 alternately has a first convex end 113 and a second end formed by two non-parallel walls 114, 115. These non-parallel walls meet. The non-parallel walls 114, 115 extend the first convex end 113 along two tangents.

In this example, the contour of the first convex end forms a circular arc of at least 180°. Other convex curves can be imagined.

The channel 10, 11 may be provided with a ridge (not shown), or several ridges, on any portion of the channel, in order to filter certain transmission modes.

The waveguides according to the first and second embodiments described may be straight or bent. It is also possible to provide combiners, for example Y-or H-shaped combiners, with several branches of cross-section as described.

The waveguide network is formed by creating waveguide lines. A first line 130 is formed by juxtaposing waveguides in an x direction perpendicular to their greatest elongation. A second line 131 is formed by juxtaposing other waveguides in the direction of their greatest elongation. The two lines are assembled head-to-tail, shifting the second line 131 by half a waveguide width relative to the first line 130. This allows the non-parallel walls 114, 115 to be shared between waveguides of two lines.

The waveguide may comprise a third line 132 of waveguides juxtaposed in the x direction, and a fourth line 133 of waveguides juxtaposed and phase-shifted relative to the third line by half a waveguide width. The second and third lines are adjacent, the waveguides being in contact via a portion of their first convex end wall.

The juxtaposition of waterdrop-shaped waveguides leaves areas unoccupied by the elementary patterns, particularly between lines 2 and 3. These areas can be filled with metal during additive manufacturing, thus forming areas of mechanical reinforcement and for heat dissipation. As the mechanical rigidity and heat dissipation are enhanced by these areas, it is possible to reduce the thickness of the waveguide walls in other areas in order to reduce the weight and size of the network.

The present invention also relates to a dual-polarization antenna array 2 obtained by additive manufacturing and including a waveguide network 1 as described above and a plurality of radiating elements coupled to the pairs of waveguides.

In one embodiment, each radiating element is connected to a pair of waveguides 10, 11 so as to transmit or receive a dual-polarization signal (P1, P2), the first waveguide 10 of the pair propagating the first polarization P1 and the second waveguide 11 of the pair propagating the second polarization P2.

Additive manufacturing is particularly well suited to the production of such waveguide networks and antenna arrays. It allows for optimized density of the various waveguide networks. In addition, it drastically reduces manufacturing time and costs. The production of monolithic parts using additive manufacturing minimizes the number of parts that need to be assembled to obtain the final device. In some cases, this number of parts is equal to one and requires no assembly.

In one embodiment, the waveguide network 1 operates as a combiner/splitter and/or as a beamforming network. Typically, the waveguide network also includes Y-junctions to function as a combiner network.

In some embodiments, the waveguide network and/or antenna array further includes elements such as a septum, impedance matching elements, power combiners and/or splitters, and passive filters.

The networks described are typically intended to operate in the X, Ku, Ka, QV, Ku/Ka, and/or Ka/QV frequency bands.

1. A waveguide network (1) obtained by additive manufacturing comprising waveguides arranged in pairs to form at least one waveguide pair, each waveguide pair comprising:
a first waveguide channel (10), and
a second waveguide channel (11);
characterized in that
the first and second channels comprise a non-circular oval cross-section with an axis of symmetry (x) and at least one non-straight portion,
and in that the first waveguide and the second waveguide have a common wall portion (100).

2. Network according to claim 1, wherein the first waveguide channel is intended to propagate a first polarization (P1) and wherein the second waveguide channel is intended to propagate a second polarization (P2).

3. Network according to one of the preceding claims, wherein the first and second channels comprise a non-circular oval section with two axes of symmetry (x, y).

4. Network according to the preceding claim, wherein said waveguide channels alternately comprise, along their longest dimension (x), a first convex end (110), a concave connecting portion (111), and a second convex end (112).

5. Network according to the preceding claim, wherein the dimension of the channel (10, 11) in a direction (y) perpendicular to said longest dimension (x) is greater at said ends than in the connecting portion.

6. Network according to the preceding claim, wherein said connecting portion comprises two concave segments facing each other.

7. Network according to the preceding claim, wherein the contour of said ends forms an arc of at least 210°.

8. Network according to one of claims 6 or 7, wherein a concave segment further comprises a ridge (14).

9. Network according to one of the preceding claims, wherein two inner walls of the first waveguide (10) and two inner walls of the second waveguide (11) comprise a ridge (14).

10. Network according to one of claims 3 to 9, wherein said waveguide channels have substantially a peanut-shaped geometric shape.

11. Network according to one of the preceding claims, comprising a first line (120) of waveguides juxtaposed in the direction (x) of their greatest elongation, and a second line (121) of waveguides juxtaposed in the direction of their greatest elongation, the second line being offset by half a waveguide length relative to the first line.

12. Network according to the preceding claim, wherein the spaces between said channels (20) form solid reinforcement zones.

13. Network according to the preceding claim, wherein the spaces between said channels form reinforcement zones (20) provided with openings (21).

14. Network according to claim 1, wherein said waveguide channels alternately comprise, along their longest dimension (x), a first convex end (113) and a second end formed by two non-parallel walls (114, 115).

15. Network according to claim 14, wherein the said non-parallel walls (114, 115) meet.

16. Network according to one of claims 14 or 15, wherein the contour of the first convex end (113) forms an arc of at least 180°.

17. Network according to one of claims 14 to 16, wherein said non-parallel walls (114, 115) extend the first convex end along two tangents.

18. Network according to one of claims 14 to 17, wherein each said channel (10, 11) comprises a ridge.

19. Network according to one of claims 14 to 18, comprising a first line (130) of waveguides juxtaposed in a direction (x) perpendicular to their greatest elongation, and a second line (131) of waveguides juxtaposed in the direction of their greatest elongation, the two lines being head-to-tail, the second line being offset by half a waveguide width relative to the first line.

20. Network according to the preceding claim, comprising a third line (132) of waveguides juxtaposed in a direction (x) perpendicular to their greatest elongation, and a fourth line (133) of waveguides juxtaposed in the direction of their greatest elongation, the third line being juxtaposed with the second line.

21. Waveguide network according to one of the preceding claims, further comprising Y-junctions for operating as a combiner network.

22. A dual-polarization antenna array (2) obtained by additive manufacturing comprising:
a waveguide network (1) according to one of the preceding claims,
a plurality of radiating elements, each radiating element being coupled to the end of exactly one pair of waveguides of the network.

23. Antenna array (2) according to the preceding claim, the waveguide network (1) comprising at least eight waveguides and the pairs of waveguides being arranged contiguously in a first direction and in a second direction, such that two successive pairs in the first direction have at least one waveguide wall in common and such that two successive pairs in the second direction have at least one waveguide wall in common.
